(19) United States
(12) Patent Application Publication
(10) Pub. No.: US 2016/0199954 A1
(43) Pub. Date: Jul. 14, 2016

(54) COMBUSTION CHAMBER FOR A GAS TURBINE, AND TOOL AND METHOD FOR PRODUCING COOLING DUCTS IN A GAS TURBINE COMPONENT

(71) Applicant: SIEMENS AKTIENGESELLSCHAFT, München (DE)

(72) Inventor: Matthias Hase, Mulheim (DE)

(73) Assignee: Siemens Aktiengesellschaft, Munich (DE)

(21) Appl. No.: 14/914,880

(22) PCT Filed: Sep. 8, 2014
(86) PCT No.: PCT/EP2014/069046

§ 371 Date: Feb. 26, 2016

(30) Foreign Application Priority Data
Sep. 9, 2013 (EP) 13183559.7

(51) Int. Cl. B23P 19/04; F23R 3/02

(52) U.S. Cl. CPC B23P 19/042; F23R 3/02

(57) ABSTRACT

A combustion chamber for a gas turbine has at least one housing component with a housing wall arranged around a hot-gas path and includes a hot side, which can be charged with hot gas, and an oppositely situated cold side. In the housing wall, there extends a number of cooling ducts each with an inner side, which cooling ducts each include an inflow region, which opens toward the cold side, and an outflow region, which opens into the interior of the combustion chamber. The combustion chamber permits cooling of the housing component, a reduction in pollutant emissions from the combustion chamber, and low production costs for the housing component. Turbulence generators are arranged in at least one of the cooling ducts, wherein the turbulence generators are web-like ribs which extend along the inner side of the cooling duct and which are formed integrally with the housing wall.

### CROSS REFERENCE TO RELATED APPLICATIONS

This application is the US National Stage of International Application No. PCT/EP2014/069046 filed Sep. 8, 2014, and claims the benefit thereof. The International Application claims the benefit of European Application No. EP13183559 filed Sep. 9, 2013. All of the applications are incorporated by reference herein in their entirety.

### FIELD OF INVENTION

The invention relates to a combustion chamber for a gas turbine with at least one housing component with a housing wall which is arranged around a hot gas path and comprises a hot side, to which hot gas can be applied, and a cold side situated opposite. A number of cooling ducts, each with an inner side, run in the housing wall of the housing component. The cooling ducts each comprise an inflow region which opens on the cold side, and an outflow region which opens into the interior of the combustion chamber.

### BACKGROUND OF INVENTION

The housing component can, for example, be the cylindrical end region of a flame tube of a tubular combustion chamber. It is known from the prior art to provide this cylindrical end region with multiple cooling ducts because this region is exposed, at least in some places, to a high degree of thermal stress. These cooling ducts can run parallel to the cylinder axis in the housing wall of the end region so that the whole area of the end region can be traversed by cooling ducts. A generic housing component can refer, for example, to a cylindrical housing component with a cylinder axis and cooling ducts, running parallel to the cylinder axis, in the housing wall of the component.

The cooling ducts can be introduced into the housing wall by means of electrochemical removal methods or electrical discharge machining. A cylindrical duct is ablated in the housing wall by means of a cylindrical rod and the abovementioned removal methods. The ducts can also be introduced into the housing component in a parallel method step by a number, which corresponds to the number of cooling channels, of such tools being used simultaneously in order to ablate the cooling ducts in the housing wall.

An increased amount of cooling air flowing through the component results in lower wear to the component. However, the cooling air flowing through the cooling ducts is no longer available as combustion air and additionally causes cold streams along the inner side of the housing component so that elevated harmful emissions of NOx and CO result.

### SUMMARY OF INVENTION

An object of the invention is to provide a combustion chamber for a gas turbine of the type mentioned at the beginning, a tool, and a method for producing the cooling ducts of the type mentioned at the beginning, which enables the housing component to be cooled, the harmful emissions from the combustion chamber to be reduced, and low production costs of the housing component.

In the case of a combustion chamber of the type mentioned at the beginning, the object is achieved according to the invention by turbulence generators being arranged in at least one of the cooling ducts which are designed as web-like ribs and extend along the inner side of the cooling duct and are formed integrally with the housing wall.

The turbulence generators according to the invention are produced at the same time as the formation of the cooling ducts on the inner side of the cooling ducts from the solid material of the housing component. This enables the housing component to be formed at particularly low production costs. The production method according to the invention, together with the tool according to the invention, makes it possible to equip the housing component with turbulence generators at no significant extra costs. The tool according to the invention allows the turbulence generators to be produced in the form of ribs which extend along the inner side of the cooling ducts and are formed integrally with the housing wall. Integrally with the housing wall is to be understood to mean that the ribs are integral with the material region which forms the inner side of the cooling duct. Because of the turbulence generators, secondary flows are initiated which increase the transfer of heat to the cooling air flowing through the cooling ducts so that, as a whole, less cooling air needs to be used for a comparable cooling of the housing component. As already mentioned above, this reduces the harmful emissions of the gas turbine.

The tool according to the invention enables precise placing and reproducibility of the turbulence generators.

The web-like ribs can advantageously run perpendicular to the longitudinal axis of the cooling duct so that the ribs have two side faces, in the form of segments of a circle or ring segments, directed transversely to the direction of flow in the cooling channel.

This orientation and form of the ribs can be produced particularly simply. At the same time, a secondary flow is initiated downstream from the turbulence generators, the power of which can be adjusted simply via the height of the ribs to increase the heat transfer.

It can also be viewed as advantageous for the web-like ribs to extend along the inner side of the cooling duct at an angle to the longitudinal axis of the cooling duct, and have two side faces, essentially in the form of segments of a circle or ring segments, directed at an angle to the direction of flow.

The angle of inclination of the ribs can preferably be 10-60 degrees. An angle of inclination of 45 degrees can be seen as particularly advantageous.

It can furthermore be advantageously provided that at least a number of ribs in the cooling duct are arranged on that side of the inner side of the cooling duct which is directed toward the hot side.

This increases the heat transfer precisely in the region of the cooling duct in which a particularly large amount of heat energy needs to be discharged.

A further advantageous embodiment of the invention can provide that the ribs are arranged on one side in the duct. For example, the height of the ribs can be selected in such a way that the ribs in each case block 5-30% of the cross-sectional surface area of the cooling duct, preferably 10-15%.

Arranging the ribs on one side, in particular toward the hot side, already permits a sufficient increase in the heat transfer.

The stated percentage of blocked cross-sectional surface area has proved to be particularly effective at increasing the heat transfer, in particular in the case of ribs arranged on one side.

A further advantageous embodiment of the invention can provide that the ribs are arranged on both sides and opposite one another in pairs in the cooling duct.

The height of the ribs can, for example, be chosen such that the opposing ribs block 10-40%, preferably 10-20% of the cross-sectional surface area of the cooling duct.

Arranging the ribs on both sides amplifies the initiated secondary flows downstream from the turbulence generators so that an improved heat transfer is effected.

The percentage of blocked cross-sectional surface area of the cooling duct has proved to be particularly effective for increasing the heat transfer, in particular in the case of ribs arranged opposite one another.

It can also be viewed as advantageous if the ribs are arranged on both sides and offset to one another in the cooling duct.

The height of the ribs can, for example, be chosen such that in each case 5-30%, preferably 10-15% of the cross-sectional surface area of the cooling duct is blocked by the ribs.

This embodiment of the invention enables a more homogeneous secondary flow, initiated by the turbulence generators, along the cooling duct, wherein the percentage of blocked cross-sectional surface area of the cooling duct has proved to be particularly effective for increasing the heat transfer, in particular in the case of ribs arranged on both sides and offset.

It can furthermore advantageously be provided that the spacing between the ribs and the next ribs arranged in each case in the longitudinal direction of the cooling duct corresponds to 5-10 times the height of the ribs.

This embodiment of the invention enables an essentially uniformly increased heat transfer along the cooling duct.

It can advantageously be provided that an inflow region of the cooling duct, which has at least a 5-10 hydraulic diameter, is designed without any ribs.

This region of the cooling duct does not need to be equipped with turbulence generators because the inlet flow into the duct here still ensures a high degree of heat transfer.

It can also be viewed as advantageous if cooling ducts, spaced apart from one another, are arranged over the whole area of the housing wall of the housing component, wherein the cooling duct including at least one turbulence generator runs in a more thermally stressed region of the housing wall.

In principle, the cooling ducts can also be equipped with ribs only in the sections which run through more thermally stressed regions.

A further object of the invention is to provide a rod-like tool of the type mentioned at the beginning for producing cooling ducts in a gas turbine component so that cooling of the housing component, a reduction in the harmful emissions from the combustion chamber, and low production costs for the housing component are enabled.

The object is achieved according to the invention with a tool of the type mentioned at the beginning by the rod-like tool having an essentially cylindrical shape at least on the first longitudinal portion, with the following recesses: at least one first recess with a first cross section which extends over the whole first longitudinal portion, and a number of grooves which each start from one of the at least one recess and which run in each case a remaining surface region of the first longitudinal portion with a groove depth.

If the tool is moved into a housing wall in an axial direction of movement by means of a removal method, those regions of the material which were not removed previously in the region of the at least one recess can be removed by subsequent rotation of the tool about an angle, wherein no material is removed in the region of the grooves so that material in the form of ribs remains at a distance from the grooves. The angle at which the tool is rotated is so wide that the region not removed by the recess can at least be traversed. If the groove depth is greater than the height of the recess, ribs remain in the form of the recess. If the groove depth is less than the height of the recess, annular ribs remain, the height of which corresponds to the groove depth.

It can advantageously be provided that the rod-like tool comprises on the first longitudinal portion precisely one recess which in particular has a cross section in the form of a segment of a circle.

The tool can be produced simply from a cylindrical rod. When moved into the housing wall with the recess, the tool can, for example, be oriented toward the hot side. This allows ribs to be arranged on that side of the cooling duct facing the hot side.

It can also be viewed as advantageous if the grooves run perpendicular to the longitudinal axis around the circumference of the first longitudinal portion.

As long as the groove depth is less than the height of the at least one recess, the groove is interrupted by the recess. When there is precisely one recess, in this case the groove runs from an edge, running parallel to the longitudinal axis, of the recess, along the convex surface to the other edge of the recess. With this exemplary embodiment of the tool, ribs arranged on one side in the cooling duct can be generated which have side faces, in the form of ring segments, directed perpendicular to the direction of flow. As long as the ribs are intended to have side faces corresponding to the recess cross section, the groove depth needs to be chosen to be correspondingly greater.

It can furthermore advantageously be provided that the grooves run at an angle relative to the longitudinal axis about the circumference of the first longitudinal portion.

Ribs can be generated with this tool which have side faces directed obliquely to the direction of flow. The angle of inclination of the ribs is determined by the angle of the grooves with respect to the longitudinal axis of the tool.

The angle can advantageously be 10-60 degrees, preferably 45 degrees.

This angle of inclination is capable of increasing the heat transfer over a longer cooling duct portion in comparison with the ribs oriented perpendicularly to the direction of flow, or with other ranges of angles of inclination.

It can furthermore advantageously be provided that the groove depth and the height of the circle segments are chosen such that cooling ducts produced using the tool have ribs arranged on one side which block the cross section of the cooling ducts by 5-30%, preferably 10-15%.

The stated percentage of blocked cross-sectional surface area has proved to be particularly effective at increasing the heat transfer, in particular in the case of ribs arranged on one side.

It can furthermore advantageously be provided that the rod-like tool comprises, on the first longitudinal portion, precisely two opposing recesses which in particular each have a cross section in the form of a segment of a circle.

This makes it possible to produce ribs, arranged on both sides, in the cooling ducts.

The grooves can run in the two remaining, convexly curved surface regions of the first longitudinal portion.

For example, the grooves can be arranged in pairs opposite or offset relative to one another.

This makes it possible to produce a continuous series of ribs, situated opposite one another in pairs, or ribs arranged offset relative to one another (on opposite sides of the duct).

It can advantageously be provided that the spacing between the grooves in the longitudinal direction of the rod-like tool is 5 to 10 times the groove depth or the height of the circle segments, depending on which of the two is the smaller.

This makes it possible to produce ribs with a spacing from the directly adjacent ribs which is 5 to 10 times their height.

The invention also relates to a tool arrangement for introducing cooling ducts into a gas turbine component, with a carrier device, in the form of a ring or a ring segment, and a number of rod-like tools which are arranged on the carrier device in such a way that the tools are fastened to the carrier device with the front end at the front and with the longitudinal axis perpendicular to the plane of the ring of said carrier device.

The tool arrangement according to the invention enables cooling ducts to be introduced into a gas turbine component such that it makes it possible for the housing component to be cooled, the harmful emissions from the combustion chamber to be reduced, and low production costs of the housing component.

For this purpose, at least one of the rod-like tools is fastened on the carrier device so that it can rotate about its longitudinal axis.

The tool arrangement enables a number of cooling ducts to be produced in parallel. The rod-like tools fastened rotatably on the carrier device can, for example, be driven using a toothed ring.

It can furthermore advantageously be provided that the tool arrangement is designed in such a way that the cooling ducts can be introduced into the gas turbine component by means of electrochemical removal methods or electrical discharge machining.

Electrochemical removal methods or electrical discharge machining are proven removal methods known to a person skilled in the art.

The invention also relates to a method for introducing cooling ducts into a gas turbine component, in particular into the housing wall of a gas turbine component of the combustion chamber as claimed.

The method enables cooling ducts to be introduced into a gas turbine component so that cooling of the housing component, a reduction in the harmful emissions from the combustion chamber, and low production costs for the housing component are enabled.

For this purpose, in order to produce a cooling duct provided with ribs, at least one rod-like tool moves in the longitudinal direction of the tool in an axial movement by means of a removal method into the gas turbine component, and in a subsequent step the regions between the ribs are removed by means of a removal method, wherein the regions are removed whilst the tool is rotated about its longitudinal axis by an angle, wherein the tool is subsequently withdrawn from the gas turbine component in a movement in an axial direction.

Cooling ducts with inclined ribs can also be generated by means of the method according to the invention.

To do this, the grooves of the tool run at an angle of inclination relative to the longitudinal axis of the tool, and, in order to remove the regions between the ribs, the tool is rotated at an angle and simultaneously moved axially in a superposed movement in accordance with the angle of inclination of the grooves.

Other expedient embodiments and advantages of the invention are the subject of the description of exemplary embodiments of the invention made with reference to the drawings, identical reference numerals referring to components which function in the same way.

### BRIEF DESCRIPTION OF THE DRAWINGS

In the drawings:

FIG. 1 shows schematically a gas turbine in a longitudinal section according to the prior art,

FIG. 2 shows schematically a tubular combustion chamber of a gas turbine in longitudinal section according to the prior art,

FIG. 3 shows a highly schematic view of an execution of a flame tube according to the prior art,

FIG. 4 shows schematically a cooling duct according to a first exemplary embodiment of the invention,

FIG. 5 shows a view in cross section of the cooling duct shown in FIG. 4,

FIG. 6 shows a further view in cross section of the cooling duct shown in FIG. 4,

FIG. 7 shows a plan view of the front end of the tool shown in FIG. 9,

FIG. 8 shows a view in cross section of the tool shown in FIG. 9,

FIG. 9 shows schematically a tool according to the invention for producing the cooling duct shown in FIG. 4,

FIG. 10 shows schematically a cooling duct according to a second exemplary embodiment of the invention,

FIG. 11 shows a view in cross section of the cooling duct shown in FIG. 10,

FIG. 12 shows a further view in cross section of the cooling duct shown in FIG. 10,

FIG. 13 shows a plan view of the front end of the tool shown in FIG. 15,

FIG. 14 shows a view in cross section of the tool shown in FIG. 15,

FIG. 15 shows schematically a tool according to the invention for producing the cooling duct shown in FIG. 10,

FIG. 16 shows schematically a cooling duct according to a third exemplary embodiment of the invention,

FIG. 17 shows a view in cross section of the cooling duct shown in FIG. 16,

FIG. 18 shows a further view in cross section of the cooling duct shown in FIG. 16,

FIG. 19 shows a plan view of the front end of the tool shown in FIG. 21,

FIG. 20 shows a view in cross section of the tool shown in FIG. 21,

FIG. 21 shows schematically a tool according to the invention for producing the cooling duct shown in FIG. 16,

FIG. 22 shows schematically a cooling duct according to a fourth exemplary embodiment of the invention,

FIG. 23 shows a plan view of the front end of the tool shown in FIG. 25,

FIG. 24 shows a view in cross section of the tool shown in FIG. 25, and

FIG. 25 shows schematically a tool according to the invention for producing the tool shown in FIG. 22.

### DETAILED DESCRIPTION OF INVENTION

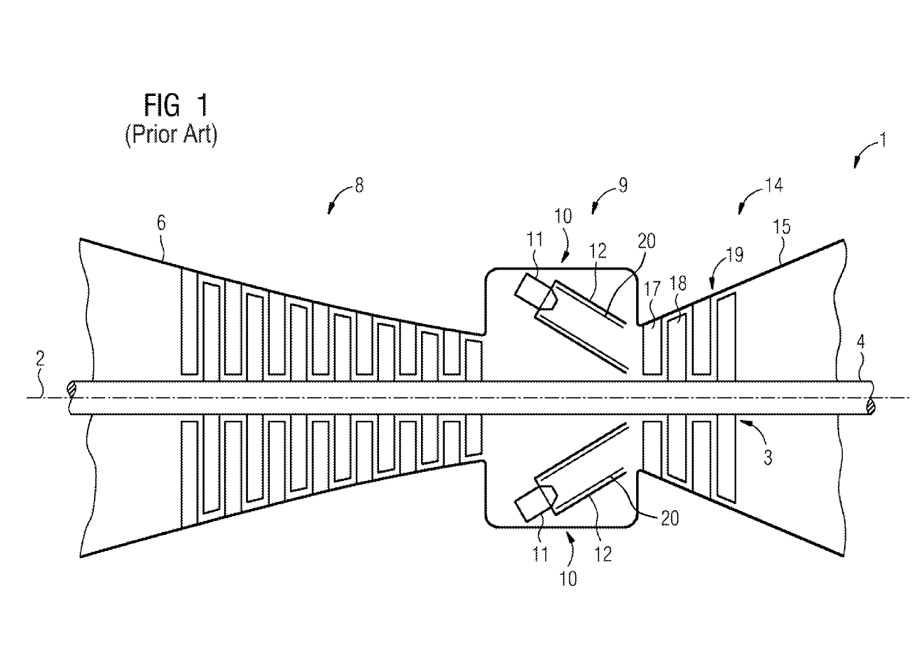

FIG. 1 shows a schematic view in section of a gas turbine 1 according to the prior art. The gas turbine 1 has inside it a rotor 3, mounted rotatably about an axis of rotation 2, with a shaft 4 which is also referred to as a turbine rotor. An intake housing 6, a compressor 8, a combustion system 9 with a number of combustion chambers 10, a turbine 14, and an exhaust gas housing 15 follow each other in succession along the rotor 3. The combustion chambers 10 each comprise a burner arrangement 11 and a housing 12 which is lined with a heat shield 20 for protection from hot gases.

The combustion system 9 communicates with a, for example, annular hot gas duct. Multiple turbine stages, for example connected in series, there form the turbine 14. Each turbine stage is formed from annular blades. Viewed in the direction of flow of a working medium, a row formed from rotor blades 18 follows a row formed from stator blades 17 in the hot gas duct. The stator blades 17 are here fastened to an inner housing of a stator 19, whereas the rotor blades 18 of a row are attached to the rotor 3 for example by means of a turbine disk. A generator (not shown) is, for example, coupled to the rotor 3.

During the operation of the gas turbine, air is sucked in through the intake housing 6 and compressed by the compressor 8. The compressed air provided at the turbine-side end of the compressor 8 is guided to the combustion system 9 and there mixed with a fuel in the region of the burner arrangement 11. The mixture is then burnt with the aid of the burner arrangement 11, a stream of working gas being formed in the combustion system 9. From there the stream of working gas flows along the hot gas duct, past the stator blades 17 and the rotor blades 18. The stream of working gas expands at the rotor blades 18 so that pulses are transmitted, so that the rotor blades 18 drive the rotor 3 and the latter drives the generator (not shown) coupled to it.

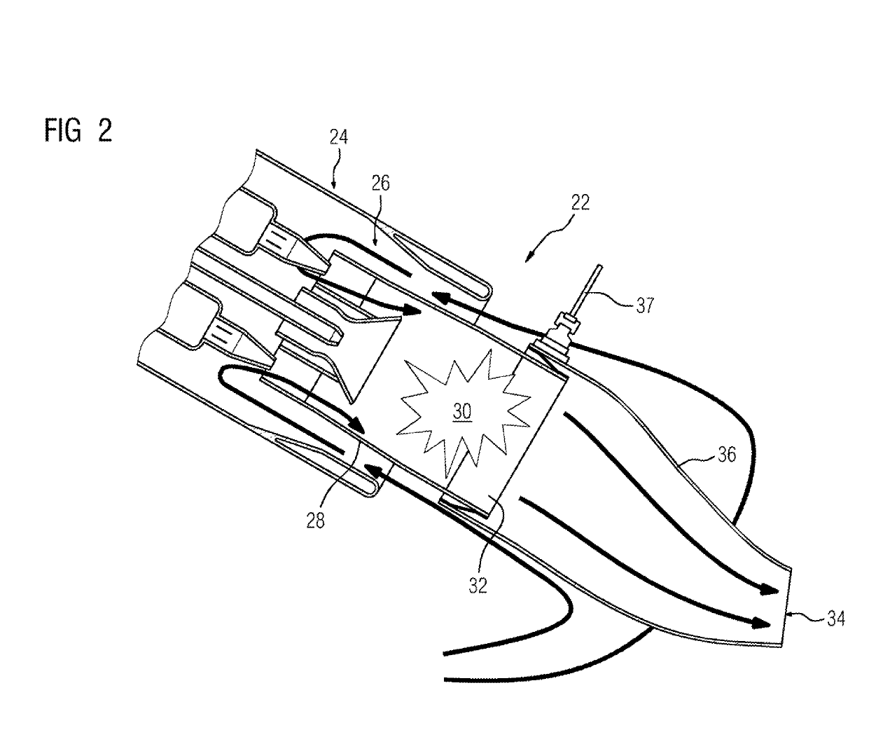

FIG. 2 shows a tubular combustion chamber 22 of a gas turbine. A burner arrangement 26 is arranged on the end of the combustion chamber head 24. The former comprises a central pilot burner and, arranged about this, a number of main burners. The main burners each comprise a burner lance, arranged centrally in the cylindrical housing of the premix section of the main burner, on which swirler blades (not shown) arranged in the premix duct are supported. The burner arrangement opens into a cylindrically designed flame tube 28 which encloses a first combustion zone 30 and comprises a cylindrical flame tube end region 32 which can be referred to as a housing component. In order to fluidically connect the flame tube end region 32 to a combustion chamber outlet 34, a transition duct 36 extends between the flame tube end region 32 and the combustion chamber outlet 34. The cylindrical flame tube end region projects into the transition duct 36.

An annular duct, sealed by means of a feather seal, which prevents thermal stresses between the two components, the flame tube and the transition duct, is in the region of the passage between the flame tube 28 and the transition duct. The transition duct is fastened at its upstream situated end to an outer housing (not shown) of the gas turbine by means of a retaining clip 37.

Because the main burners each generate a flame in the first combustion zone 30 downstream from their burner outlets, the thermal stress in the regions situated downstream from the burner outlets is greater than in the regions between them. The flame tube end region 32 is thus not evenly thermally stressed around its circumference. The flame tube end region 32 is a gas turbine component with a housing wall 23 which is arranged around a hot gas path and comprises a hot side 25, to which hot gas can be applied, and an opposite cold side 27. The housing wall 23 of the flame tube end region 32 has a number of cooling ducts.

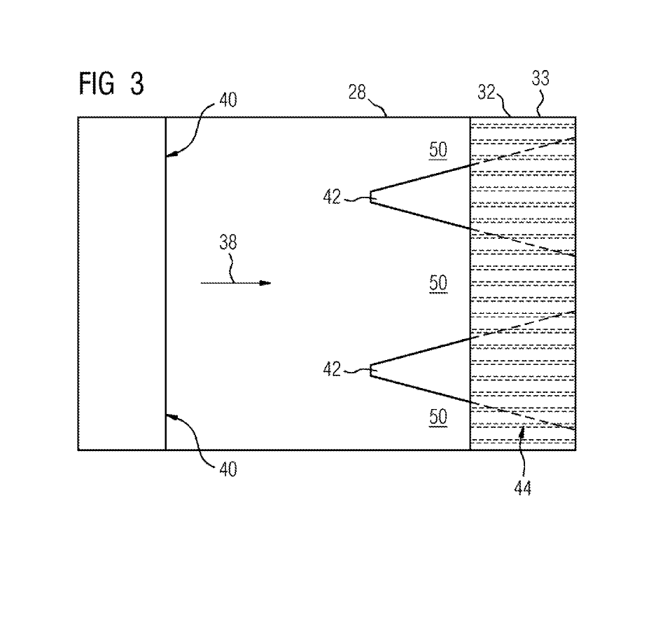

FIG. 3 shows a highly schematically simplified view of an execution of a flame tube 28 (which can also be referred to as a bucket) according to the prior art. A main flow direction in the combustion chamber is illustrated with the arrow 38 so that the terms upstream and downstream can be used in FIG. 3. The region 40 indicates the burner outlets of two burners (the burners can also be referred to as main swirl generators) of the burner arrangement. Widening regions 42 of the flame tube (here shown schematically with a triangular shape), which are more thermally stressed (considerably higher wall temperature), are thus formed downstream from the burner outlets. The cones signify the increase in the basket wall temperature by the flame, which relates to a larger and larger circumference of the basket in the direction of flow. The drawing is a schematic diagram which approximately replicates the situation in the combustion system. The regions 42 extend into the flame tube end region 32. Regions 50 which are less thermally stressed are situated between these regions 42. The flame tube end region 32 can also be referred to as a housing component 33 which has a housing wall in which cooling ducts 44 run which extend parallel to the main direction of flow 38 and are uniformly spaced apart from one another.

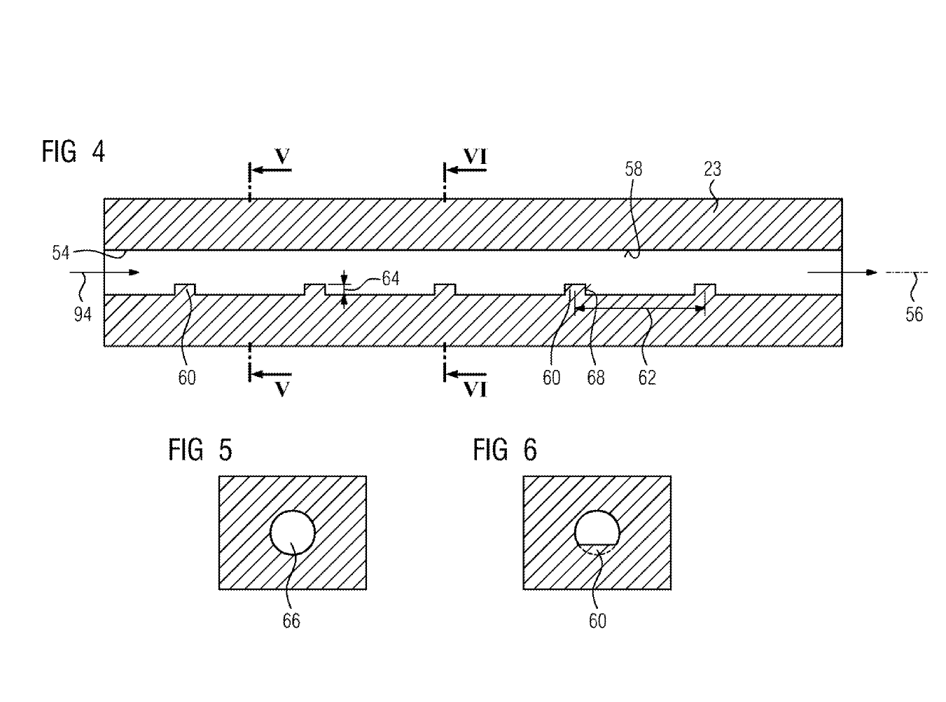

FIG. 4 shows a portion of a cooling duct 54 according to a first exemplary embodiment of the invention. The cooling duct 54 extends rotationally symmetrically about a longitudinal axis 56 with an inner side 58 with a cylindrical shape. Turbulence generators which are designed as web-like ribs 60 are arranged in the cooling duct 54.

The web-like ribs 60 extend along the inner side 58 of the cooling duct 54 and are designed integrally with the housing wall 23. The ribs 60 are arranged on one side in the cooling duct 54 and, in the longitudinal direction of the cooling duct, have a spacing 62 from the directly adjacent ribs. These spacings can be the same but do not always need to be. The spacing is advantageously 5-10 times the height 64 of the ribs.

In addition, FIG. 5 and FIG. 6 show two views in cross section of the cooling duct 54 along the respective planes of section. The circular cross section of the cooling duct 54 can be seen in the view in FIG. 5, with a cross-sectional surface area 66. The view in FIG. 6 shows a cross section through the cooling duct 54 in the region of a rib 60. The web-like rib 60 runs perpendicular to the longitudinal axis 56 of the cooling duct 54 so that the rib 60 has two side faces 68, in the form of segments of a circle, directed transversely to the direction of flow in the cooling duct.

FIG. 9 shows, in a highly schematized manner, the rod-like tool 70 according to the invention for producing the cooling duct 54 shown in FIG. 4 in a housing component 33 of a gas turbine. The tool 70 extends along a longitudinal axis 72 from a front end 74, over a first longitudinal portion 76 adjoining the front end, to an opposite end 71. In the exemplary embodiment shown, the first longitudinal portion 76 extends over the entire length of the tool 70.

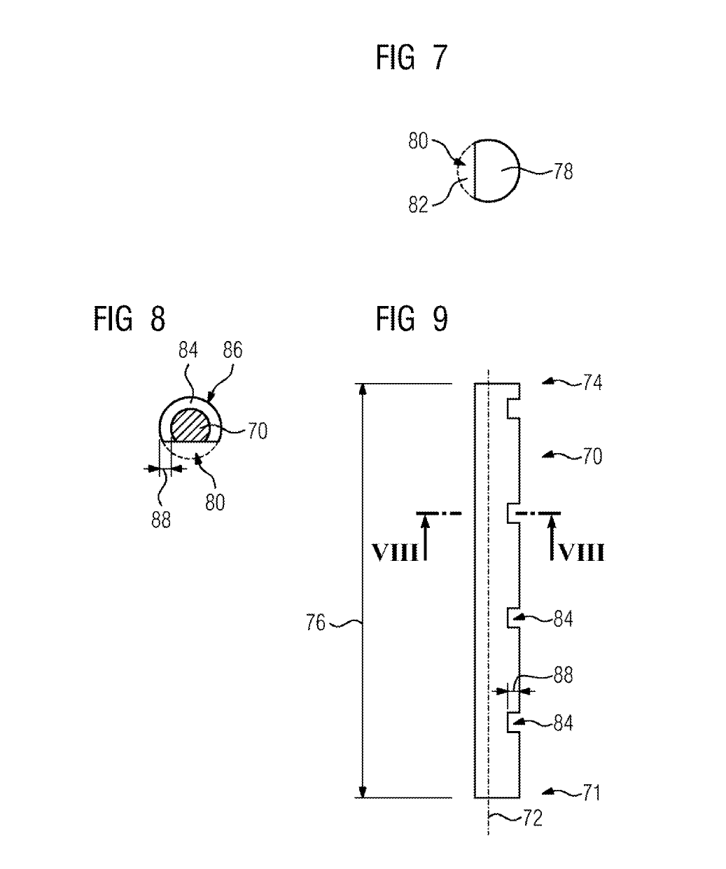

In a different design of the tool 70, the cross section 78 of the first longitudinal portion is shown separately in FIG. 7. The circular cross section 78 is reduced by a segment of a circle. The rod-like tool 70 thus has, on the first longitudinal portion 76, an essentially cylindrical shape with precisely one first recess 80 extending over the entire first longitudinal portion. The recess 80 has a cross section 82 in the form of a segment of a circle. The rod-like tool 70 also comprises a number of grooves 84 which extend perpendicular to the longitudinal axis 72. The detail in FIG. 8 shows a view in cross section of the tool 70 in the region of a groove 84. The groove 84 runs in a remaining surface region 86 of the first longitudinal portion 76 with a groove depth 88. The grooves 84 run from the first edge of the recess 80 to the other edge of the recess 80.

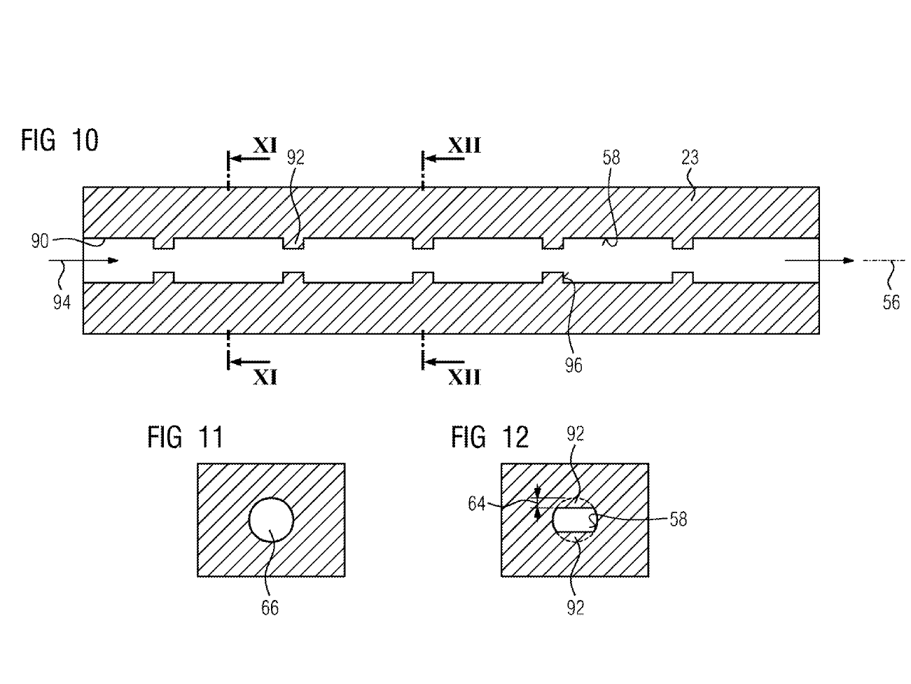

FIG. 10 shows a cooling duct 90 in a housing wall 23 according to a second exemplary embodiment of the invention. The cooling duct 90 differs from the cooling duct shown in FIG. 4 in that the web-like ribs 92 are arranged in the cooling duct 90 on both sides and in pairs opposite one another. The ribs 92 run transversely to the direction of flow 94 along the inner side 58 of the cooling duct 90 so that the side faces 96, in the form of segments of a circle, stand transversely to the direction of flow. The ribs 92 have a height 64. The two ribs 92 together block, as shown in detail in FIG. 12, the cross-sectional surface area 66 by a certain percentage. In the case of the ribs arranged opposite one another in pairs, this percentage can, for example, be 10-40%, preferably 10-20% of the cross-sectional surface area of the cooling duct 90. This percentage has been shown to be advantageous for increasing the heat transfer in the cooling duct.

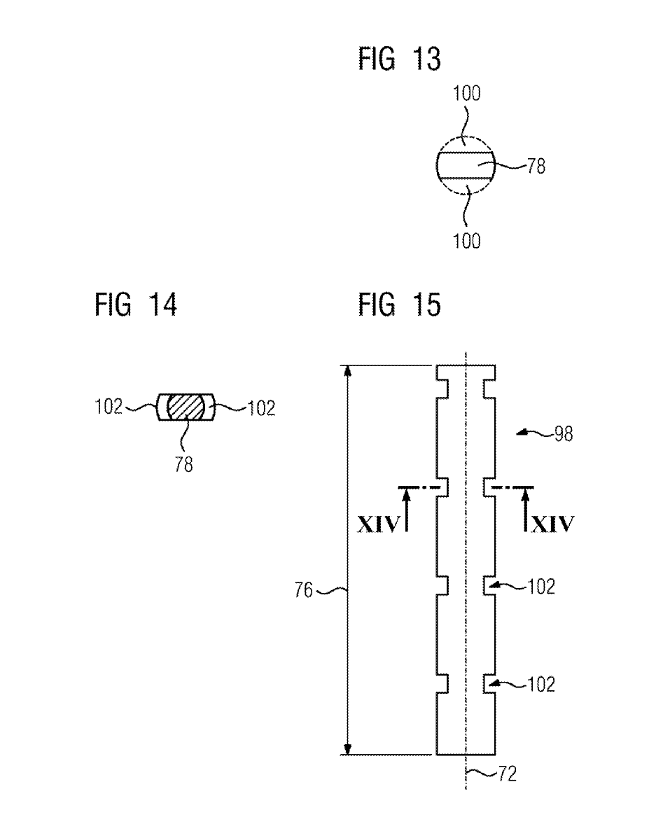

FIG. 15 shows, in a highly schematized manner, the rod-like tool 98 according to the invention for producing the cooling duct 90 shown in FIG. 10. The tool 98 differs from the tool shown in FIG. 9 in that precisely two opposing recesses 100 extend along the first longitudinal portion 76 (see also the view in cross section in FIG. 13). The grooves 102 run (as illustrated in detail in the view in cross section in FIG. 14) in the two remaining, convexly curved surface regions of the first longitudinal portion 76, wherein the grooves 102 run in pairs opposite one another.

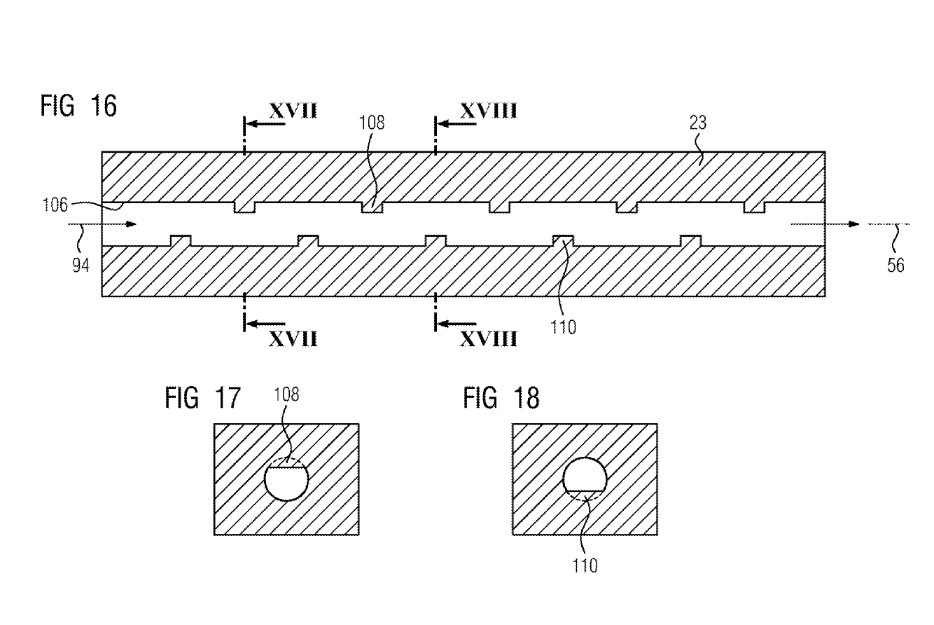

FIG. 16 shows a cooling duct 106 in a housing wall 23 according to a third exemplary embodiment of the invention. The cooling duct 106 differs from the cooling duct shown in FIG. 10 in that the web-like ribs are arranged on both sides but offset in the cooling duct 106. The ribs 108 are situated on one side. The ribs 110 are situated on the opposite side. See also the views in cross section in FIGS. 17 and 18 along the planes of section XVII and XVIII.

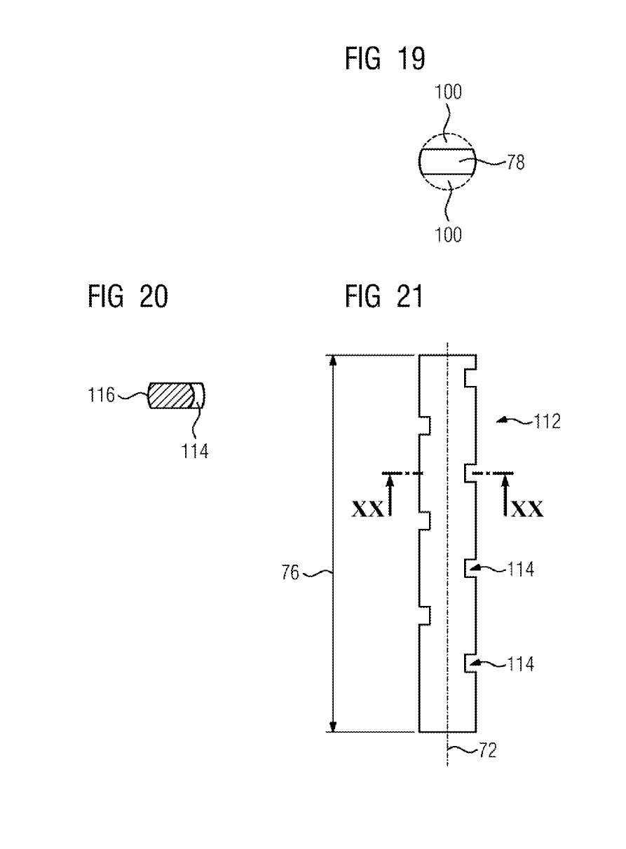

FIG. 21 shows, in a highly schematized manner, the rod-like tool 112 according to the invention for producing the cooling duct 106 shown in FIG. 16. The tool 112 differs from the tool shown in FIG. 15 in that the grooves 114 are arranged offset relative to one another (i.e. not opposite one another) in the two remaining, convexly curved surface regions 116 of the first longitudinal portion 76. The cross section in the region of the plane of section XX is shown in FIG. 20. FIG. 19 shows a cross section of the tool with the two opposing recesses.

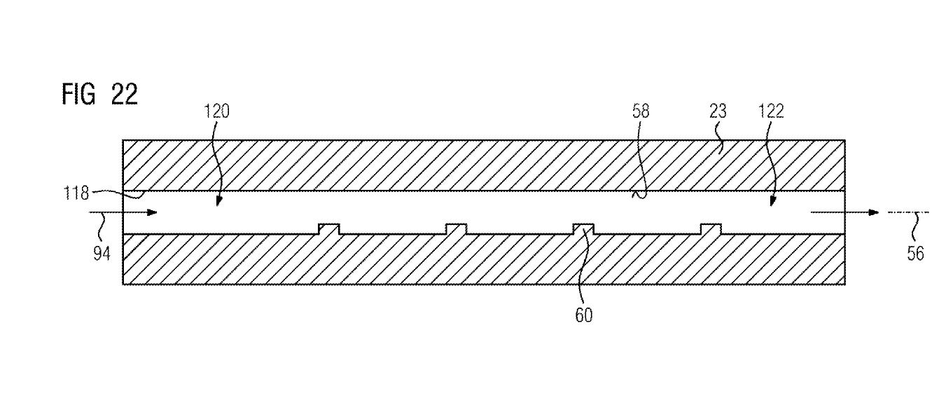

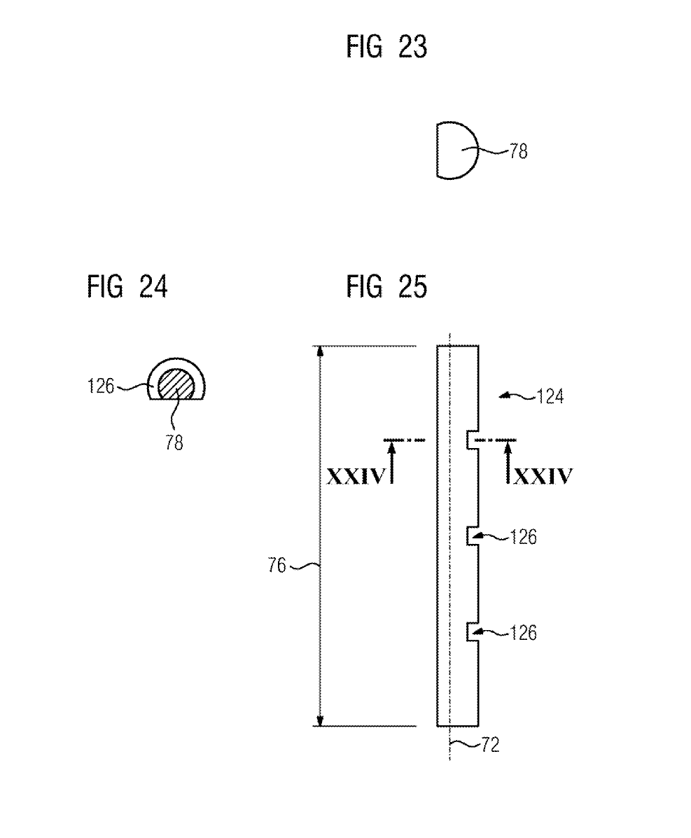

FIG. 22 shows a cooling duct 118 according to a fourth exemplary embodiment of the invention. It differs from the cooling duct shown in FIG. 4 in that an inflow region 120 and an outflow region 122 are designed with no ribs. The cooling duct 118 can be generated by means of a tool 124 according to the invention shown in FIG. 25. The grooves 126 are distributed in a central region of the first longitudinal portion 76 so that a cooling duct produced with the tool is designed without ribs in the regions situated upstream and downstream. The length of the tools of all the exemplary embodiments shown here in all cases corresponds essentially to the length of the cooling ducts to be produced with the tool. FIG. 23 and FIG. 24 show cross sections of the tool shown in FIG. 22.

1.-24. (canceled)

25. A method for introducing cooling ducts into a gas turbine component, the method comprising:
in order to produce a cooling duct provided with ribs, moving at least one rod-like tool in the longitudinal direction of the tool in an axial movement by a removal method into the gas turbine component, the removal method comprising extending the rod-like tool along a longitudinal axis from a front end over a first longitudinal portion adjacent to the front end to an opposite end,
wherein the rod-like tool has an essentially cylindrical shape at least on the first longitudinal portion, with the following recesses: at least one first recess with a first cross section which extends over the whole first longitudinal portion, and a number of grooves which each start from one of the at least one recess and which run in, in each case, a remaining surface region of the first longitudinal portion with a groove depth, and
in a subsequent step, removing the regions between the ribs by a removal method comprising removing the regions whilst the tool is rotated about its longitudinal axis by an angle and subsequently withdrawing the tool from the gas turbine component in a movement in an axial direction.

26. The method as claimed in claim 1,
wherein the grooves of the tool run at an angle of inclination relative to the longitudinal axis of the tool, and,
in order to remove the regions between the ribs, the tool is rotated at an angle and simultaneously moved axially in a superposed movement in accordance with the angle of inclination of the grooves.

27. The method as claimed in claim 1,
wherein gas turbine component comprises a housing wall of a combustion chamber.
